(19) United States
(12) Patent Application Publication
(10) Pub. No.: US 2008/0301774 A1
(43) Pub. Date: Dec. 4, 2008

(54) INFORMATION PROCESSING APPARATUS

(75) Inventor: Shuji Hori, Iruma-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/023,686

(22) Filed: Jan. 31, 2008

(30) Foreign Application Priority Data
May 28, 2007 (JP) 2007140879

(51) Int. Cl. G06F 21/00

(52) U.S. Cl. 726/3; 726/16

(57) ABSTRACT

An information processing apparatus includes: a processor; a first auxiliary storage device that stores data; a second auxiliary storage device that is provided separate from the first auxiliary storage device at a position inaccessible to a user, the second auxiliary storage device being configured to be rewritable; and a firmware memory that stores a firmware program that is initially executed when a power of the apparatus is turned on, wherein the firmware program causes the apparatus to operate: performing an user authentication; permitting an access to the first auxiliary storage device when the user authentication is successful; and initiating an authentication failure processing program that is stored in the second auxiliary storage device to be performed by the processor when is the user authentication is unsuccessful.

### CROSS-REFERENCE TO RELATED APPLICATIONS

This application is based upon and claims the benefit of priority from Japanese Patent Application No. 2007-140879, filed on May 28, 2007, the entire content of which are incorporated herein by reference.

### BACKGROUND

1. Field

One embodiment of the invention relates to an information processing apparatus that performs user authentication when power is turned on.

2. Description of the Related Art

Known information processing apparatuses that perform authentication when accessing information are disclosed in JP-A-2004-355137 and JP-A-2006-309532. In the information processing system disclosed in JP-A-2004-355137, the information processing apparatus performs authentication by reading information for authentication from a mounted cartridge device. A disk device is started when the authentication is successful, and a warning is displayed when the authentication fails. The information processing apparatus disclosed in JP-A-2006-309532 performs user authentication when power is turned on. If an unauthorized user fails in the authentication, the unauthorized use is notified while making a display as if the authentication was successful, such that the unauthorized use of the apparatus is detected without making the unauthorized user recognize the notification. Typically, the user authentication when power is turned on in such information processing apparatus is performed by a BIOS (basic input output system) program, and processing at the time of failure of authentication is also performed according to the BIOS program.

However, since a BIOS ROM stored with a BIOS program generally has a limited capacity, it is not possible to prepare a high-capacity BIOS program and it is difficult to perform complicated processing when authentication fails. In addition, since such BIOS program is built in the BIOS ROM when manufacturing the information processing apparatus, a user of the apparatus could not set the BIOS program freely and it was not possible to allow the user to manage processing at the time of failure of authentication.

### SUMMARY

One of objects of the present invention is to provide an information processing apparatus that allows a user to manage a case where user authentication when power is turned on fails.

According to a first aspect of the present invention, there is provided an information processing apparatus including: a processor; a first auxiliary storage device that stores data; a second auxiliary storage device that is provided separate from the first auxiliary storage device at a position inaccessible to a user, the second auxiliary storage device being configured to be rewritable; and a firmware memory that stores a firmware program that is initially executed when a power of the apparatus is turned on, wherein the firmware program causes the apparatus to operate: performing an user authentication; permitting an access to the first auxiliary storage device when the user authentication is successful; and initiating an authentication failure processing program that is stored in the second auxiliary storage device to be performed by the processor when the user authentication is unsuccessful.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view illustrating a computer according to an embodiment of the present invention.

FIG. 2 is a block diagram illustrating a system configuration of the computer shown in FIG. 1.

FIG. 3 is a flow chart illustrating processing when starting the computer shown in FIG. 1.

FIG. 4 is a flow chart illustrating processing in the computer shown in FIG. 1 when a supervisor password is deleted.

### DETAILED DESCRIPTION

An embodiment of the present invention will be described by referring to an information processing apparatus and accompanying drawings.

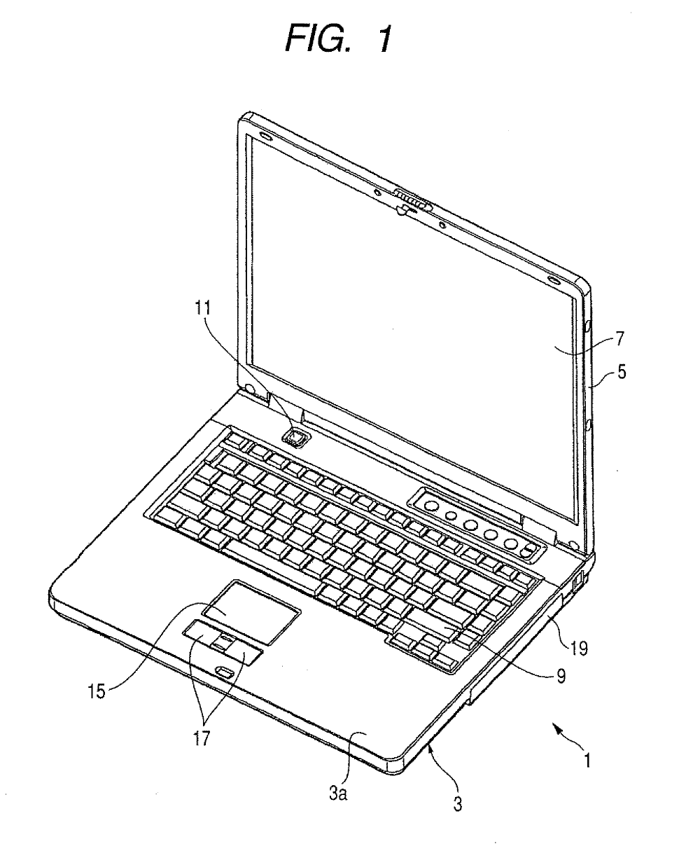

A laptop computer (information processing apparatus) 1 shown in FIG. 1 includes a main body 3 and a display unit 5 that is freely opened and closed with respect to the main body 3. A TFT-LCD (thin film transistor liquid crystal display) 7 is provided as a display device in the display unit 5. A display screen of the LCD 7 is located approximate center of the display unit 5.

The display unit 5 is attached so as to freely rotate between an opened position and a closed position with respect to the main body 3. The main body 3 has a housing having a thin boxed shape. A keyboard 9, a power switch 11 for turning on/off the computer 1, a touch pad 15, and a click button 17 are provided on a top surface of the main body 3.

The computer 1 is configured to reproduce audio/video (AV) contents stored in DVD media. A slot 19 for inserting DVD media is provided on a side surface of the main body 3.

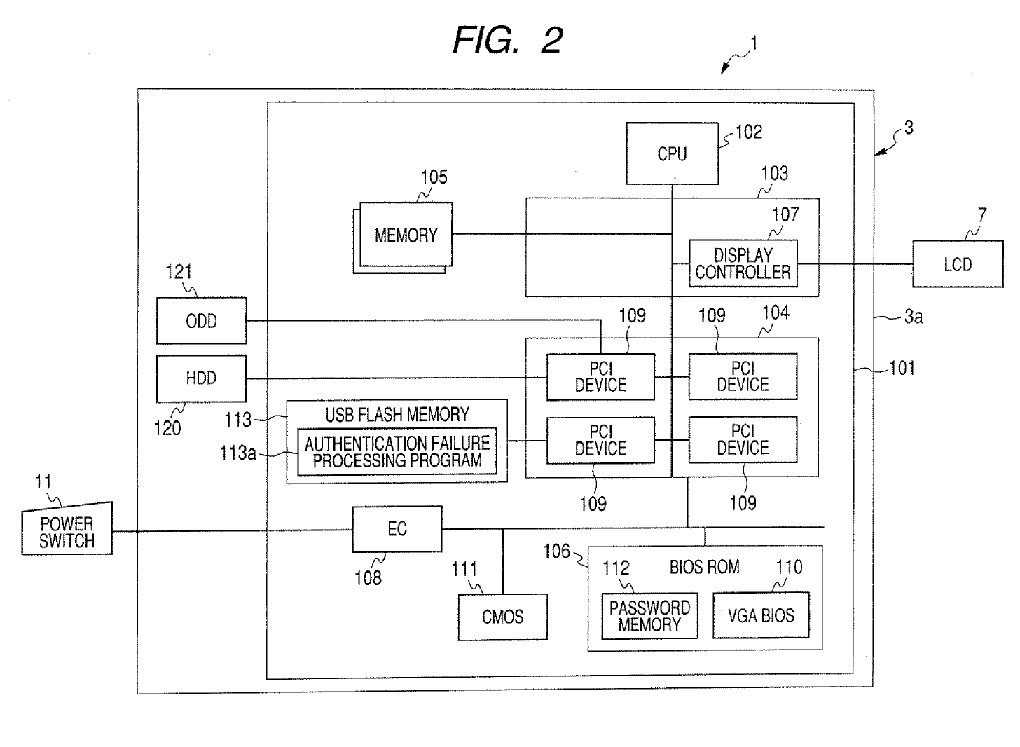

As shown in FIG. 2, a mother board 101 is built in a housing 3a that forms the outer casing of the main body 3. Semiconductor chips, such as a CPU 102 serving as a main operation unit, a north bridge 103, and a south bridge 104, are mounted on the mother board 101. The north bridge 103 is a chip that performs a control related to a memory or display, and the south bridge 104 is a chip that performs a control of a PCI device, an LPC device, and the like. The LCD 7 of the display unit 5 is connected to a display controller 107 of the north bridge 103. A hard disk drive (HDD: first auxiliary storage device) in which an OS (operating system), various kinds of applications, data files, and the like are stored is built in the housing 3a. An optical disk drive (ODD) into which an optical disk, such as a DVD disk, can be inserted from the outside is also built in the housing 3a.

A memory 105 and BIOS ROM (BIOS memory; firmware memory) 106 are mounted on the mother board 101. Programs, such as a BIOS and an OS, are loaded into the memory 105 so as to be executed by the CPU 102. A BIOS program that controls the computer 1 is stored in the BIOS ROM 106. A BIOS program (firmware program) that controls a display controller is stored in a VGA BIOS 110 of the BIOS ROM 106. A password memory 112 is a non-volatile memory used to store a user password and a supervisor password. A CMOS 111 stores information required when starting the computer 1.

PCI devices 109, such as a SATA controller and a USB controller, are included in the south bridge 104. The HDD 120, ODD 121, and various kinds of USB devices described above are connected to the south bridge 104 through the PCI device 109. An EC (embedded controller) 108 is a chip that performs power management of the computer 1, and the EC 108 is connected with the power switch 11 exposed on the top surface of the housing 3a.

A USB flash memory (second auxiliary storage device) 113 is connected to the south bridge 104 through the PCI device 109. The USB flash memory 113 is a non-volatile storage device capable of reading and writing a program, and an authentication failure processing program 113a is stored in the USB flash memory 113. The authentication failure processing program 113a is a program that performs appropriate processing when user authentication at the start of the computer 1 fails. As such program, a suitable program prepared by a supervisor of the computer 1 may be adopted. That is, a user authenticated as a user with supervisor privilege may write the authentication failure processing program 113a, which is prepared by the user, in the USB flash memory 113.

Physically, the USB flash memory 113 is directly attached on a substrate of the mother board 101. Accordingly, the USB flash memory 113 cannot be easily detached from the mother board 101. Thus, since the mother board 101 is built within the housing 3a, it is difficult for a user of the computer 1 to take out the USB flash memory 113. With the configuration described above, it is possible to reduce a risk that the USB flash memory 113 will be taken away, such that the authentication failure processing program 113a will be reverse engineered.

In the computer 1, two-step user privilege including ‘supervisor privilege’, which corresponds to a supervisor of the computer 1, and ‘user privilege’, which corresponds to a mere user of the computer 1, is set. An user having supervisor privilege and a user having user privilege are set, respectively, by recording a supervisor password and a user password in the password memory 112. Editing of the supervisor password and the user password can be performed by using a setting change function of a BIOS program and a password utility operating on an OS.

A BIOS program executed when starting the computer 1 may control whether or not to permit to use (access) each of the auxiliary storage devices (HDD 120, ODD 121, and USB flash memory 113) corresponding to the privilege of a user, for every auxiliary storage device. In an auxiliary storage device set to be unusable, access corresponding to an I/O level after the start of the computer 1 is not allowed either. Such control function may be called a ‘device access control function’ in the following description. A BIOS program causes a user to enter a password when the computer 1 is turned on and determines the user's privilege on the basis of the password.

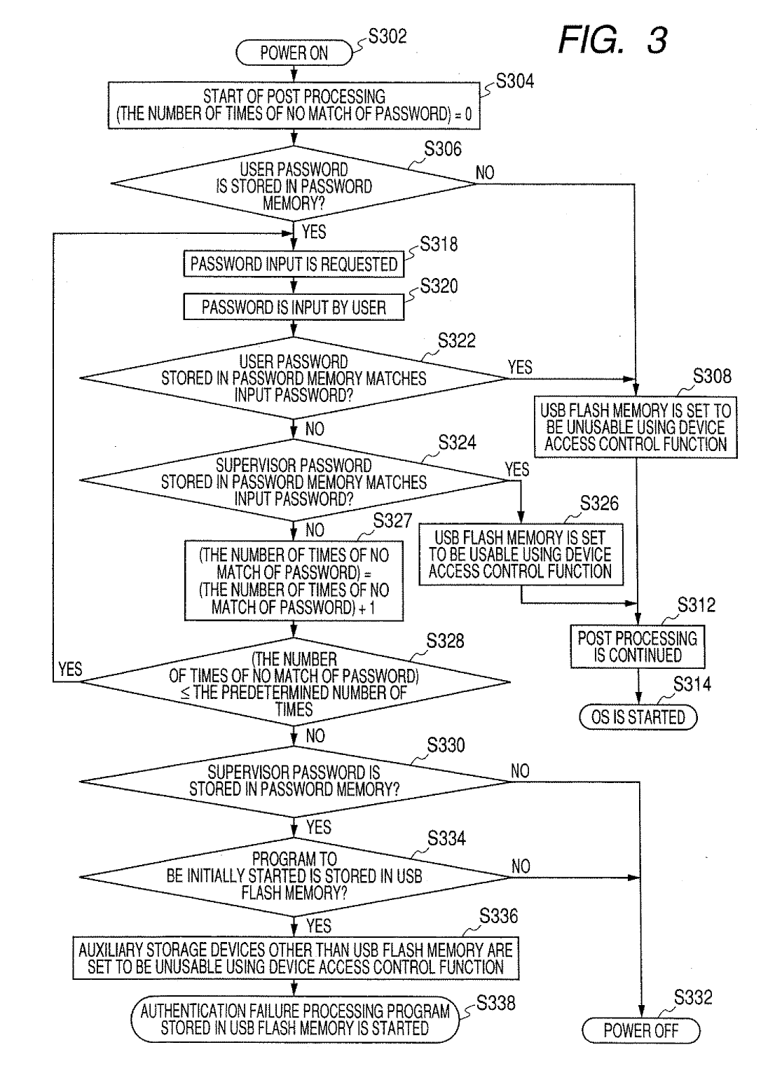

Subsequently, an operation at the start of the computer 1 will be described with reference to FIG. 3.

When the power switch 11 of the computer 1 is operated to supply power (S302), supply of power is notified from the EC 108 to the BIOS ROM 106, and accordingly, a BIOS program starts to initiate POST processing (S304). At this point of time, a “number of times of input of an incorrect password” (wilt be described later) is set to 0. Here, the BIOS program is loaded into the memory 105 and executed by the CPU 102.

Then, the BIOS program checks whether or not the user password is stored in the password memory 112 (S306). When determined that the user password is not stored in the password memory 112 in step S306, the BIOS program sets the USB flash memory 113 to be unusable by using the device access control function (S308). Thereafter, POST processing is continued (S312), in which the BIOS program sets auxiliary storage devices (HDD 120, ODD 121, and the like) other than the USB flash memory 113, which are built in the computer 1, using the device access control function. After the POST processing is completed, the OS stored in the HDD 120 is loaded into the memory 105 and is then started and executed by the CPU 102 (S314).

As described above, a case in which a user password is not stored in the password memory 112 means that a user with user privilege is not set. In this case, since input of a password is not requested, the HDD 120 and the ODD 121 may be used without limit of a user. Accordingly, it is possible to access data stored in the HDD 120 and the ODD 121. Even in this case, as described above, the USB flash memory 113 is set to be unusable. Accordingly, there is little chance that the authentication failure processing program 113a stored in the USB flash memory 113 will be stolen, broken, or reverse engineered by an unauthorized user.

On the other hand, when the user password is stored in the password memory 112 in step S306, the BIOS program displays on the LCD 7 a screen that requests to enter a password (S318). The user of the computer 1 enters a password in response to the screen (S320).

Here, when the password that the user entered matches a user password stored in the password memory 112 (S322), the user is authenticated as a “user having user privilege”. Further, in this case, the BIOS program sets the USB flash memory 113 to be unusable using the device access control function (S308). Then, the BIOS program performs the processing of step S312 and the processing of S314, such that the OS stored in the HDD 120 is loaded into the memory 105 and is then executed by the CPU 102.

Thus, in the case when the user is authenticated as a “user having user privilege”, the HDD 120 and the ODD 121 become usable, and accordingly, the OS starts. As a result, since the user with user privilege can use the computer 1, it is possible to access the data stored in the HDD 120 and the ODD 121. Even in this case, as described above, the USB flash memory 113 is set to be unusable. Accordingly, there is little chance that the authentication failure processing program 113a stored in the USB flash memory 113 will be stolen, broken, or reverse engineered by a mere user with user privilege.

When a password that the user entered matches a supervisor password stored in the password memory 112 (S324), the user is authenticated as a “user having supervisor privilege”. Then, the BIOS program sets the USB flash memory 113 to be usable using the device access control function (S326). Then, the BIOS program performs the processing of step S312 and the processing of S314, such that the OS stored in the HDD 120 is loaded into the memory 105 and is then executed by the CPU 102.

Thus, in the case when the user is authenticated as a “user having supervisor privilege”, the HDD 120 and the ODD 121 become usable, and accordingly, the OS starts. As a result, the user with supervisor privilege can use the computer 1. In this case, the USB flash memory 113 can also be used. Accordingly, the user with supervisor privilege user can read or rewrite the authentication failure processing program 113a stored in the USB flash memory 113.

On the other hand, if the password that the user entered does not match both the user password and the supervisor password, the BIOS program adds “1” to the “number of times of input of an incorrect password” (S327), confirms that the “number of times of input of an incorrect password” does not exceed the predetermined number of times (S328), and then returns to the processing (S318) in which input of a password is requested again. In addition, the predetermined number of times is set beforehand by BIOS setting, for example.

In step S328, if the “number of times of input of an incorrect password” exceeds the predetermined number of times, the BIOS program determines that authentication has failed and performs the following processing. First, the BIOS program checks whether or not a supervisor password is stored in the password memory 112 (S330). Here, if the supervisor password is not stored in the password memory 112, the BIOS program notifies the EC 108 to turn off power (S332), such that the computer 1 is turned off.

On the other hand, if the supervisor password is stored in the password memory 112 in S330, the BIOS program checks whether or not a program that can be started is stored in the USB flash memory 113 (S334). If a program that can be started is not stored in the USB flash memory 113 in step S334, the BIOS program notifies the EC 108 to turn off power (S332), such that the computer 1 is turned off.

If a program that can be started is stored in the USB flash memory 113 in step S334, the BIOS sets auxiliary storage devices (HDD 120, ODD 121, and the like) other than the USB flash memory 113 using the device access control function (S336). Thereafter, the BIOS program boots up (initiates) the authentication failure processing program 113a stored in the USB flash memory 113 (S338). The authentication failure processing program 113a is loaded into the memory 105 and executed by the CPU 102. As described above, since the authentication failure processing program 113a is a program prepared in advance by a user with supervisor privilege, the user with supervisor privilege can perform desired authentication failure processing prepared in advance.

For example, in the case when the authentication has failed, it is considered that there is a possibility that an unauthorized user has tried to start the computer 1. Accordingly, it is considered to adopt processing for notifying a supervisor that the authentication has failed through a LAN, processing for photographing the user and storing the user's photo by using a camera connected to the computer 1, or processing for generating loud warning beep from the computer 1. It is difficult to realize such complicated processing by using only a relatively low-capacity BIOS program. Accordingly, it has been common in the known computer to turn off power when the authentication fails.

However, in the computer 1, the more complicated authentication failure processing program 113a can be stored in the USB flash memory 113 by increasing the capacity of the USB flash memory 113. As a result, when the authentication fails, it is possible to execute the complicated processing that the user with supervisor privilege desires. In the computer 1, for example, it is also possible to realize processing using a graphic user interface, a sound, or a moving picture at the time of failure of authentication.

In addition, since the BIOS program is built in the BIOS ROM 106 when the computer 1 is manufactured, even the user with supervisor privilege cannot change the BIOS program freely. In contrast, since the authentication failure processing program 113a is written in the USB flash memory 113 that is readable and writable, the user with supervisor privilege can freely set processing at the time of failure of authentication. Thus, the processing at the time of failure of authentication can be managed by the user with supervisor privilege.

Furthermore, as described above, in the cases when a user password is not stored in the password memory 112 and when a user is authenticated as a user with user privilege, the USB flash memory 113 is set to be unusable. Therefore, there is little chance that the authentication failure processing program 113a will be stolen, broken, or reverse engineered by a user other than the user with supervisor privilege.

In addition, before the authentication failure processing program 113a is started, the HDD 120 and the ODD 121 are set to be unusable (S336). Therefore, even if an attempt of unauthorized access to the computer 1 is made from the outside after authentication has failed, data files stored in the HDD 120 and the ODD 121 can be protected from the unauthorized access.

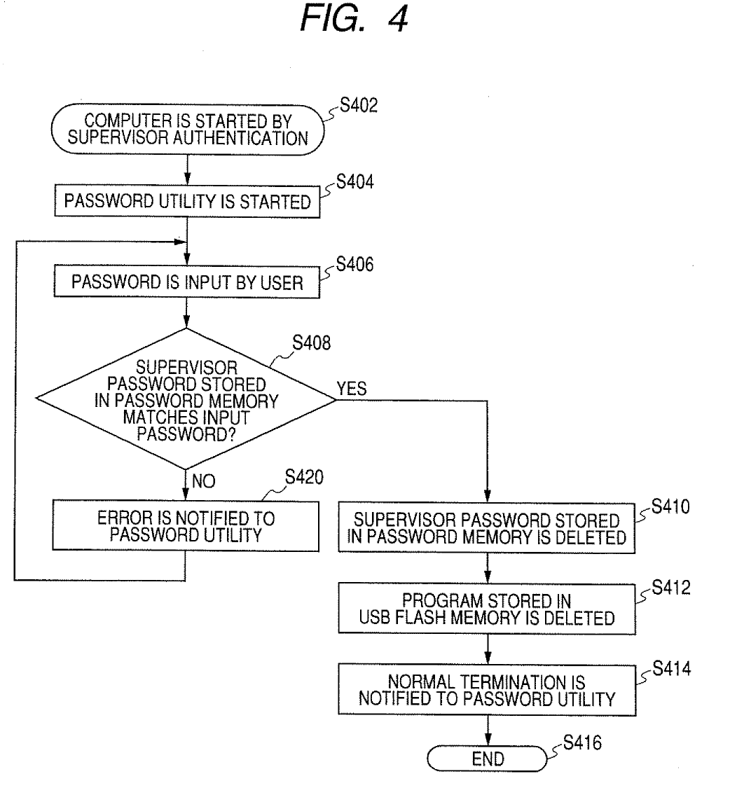

Subsequently, processing for deleting a supervisor password stored in the password memory 112, which is performed in the computer 1, will be described with reference to FIG. 4. First, when the user starts a predetermined password utility (S404) in a state where a user has started the computer 1 in the capacity of a user with supervisor privilege (S402) the password utility causes the user to enter a password (S406). When the password is entered in the password utility, a BIOS program determines whether or not the password matches a supervisor password stored in the password memory 112 (S408). Here, if the password does not match the supervisor password stored in the password memory 112, the BIOS program notifies the password utility of an error (S420), and the password utility that has received the error notification requests the user to enter a password again (S406).

If the password matches the supervisor password stored in the password memory 112 in step S408, the BIOS program deletes the supervisor password stored in the password memory 112 (S410). Then, the BIOS program deletes the authentication failure processing program 113a stored in the USB flash memory 113 (S412). Then, the BIOS program notifies the password utility of normal termination (S414) and the password utility terminates the processing (S416). In addition, the processing (S406) for inputting of a password may be performed using a setting change function of the BIOS instead of the password utility.

Conceivably, deletion of a supervisor password performed by a user with supervisor privilege means that management of the computer 1 is abandoned. Accordingly, in this case, the authentication failure processing program 113a stored in the USB flash memory 113 is automatically deleted by the processing described above (S412). As a result, after the management of the computer 1 is abandoned, for example, even in the case when a new supervisor password is set, there is little chance that the authentication failure processing program 113a will be reverse engineered.

The present invention is not limited to the embodiment described above. For example, although the authentication failure processing program 113a is stored in the USB flash memory 113 built in a main body of the computer 1 in the embodiment described above, any types of storage devices may be adopted instead of the USB flash memory 113 as long as the storage devices are non-volatile storage devices built in the main body of the computer 1 and can be provided separately from the HDD 120. In addition, although user authentication is performed by causing a user to enter a password in the embodiment described above, other types of user authentication, such as fingerprint authentication, may be performed.

What is claimed is:

1. An information processing apparatus comprising:
a processor;
a first auxiliary storage device that stores data;
a second auxiliary storage device that is provided separate from the first auxiliary storage device at a position inaccessible to a user, the second auxiliary storage device being configured to be rewritable; and
a firmware memory that stores a firmware program that is initially executed when a power of the apparatus is turned on,
wherein the firmware program causes the apparatus to operate:
performing an user authentication;
permitting an access to the first auxiliary storage device when the user authentication is successful; and
initiating an authentication failure processing program that is stored in the second auxiliary storage device to be performed by the processor when the user authentication is unsuccessful.

2. The apparatus according to claim 1, wherein the firmware program causes the apparatus to further operate:
controlling permission for accessing the second auxiliary storage device in accordance with a result of the user authentication; and
permitting to read and write the second auxiliary storage device when the user authentication is successful for a supervisor privilege that is previously set.

3. The apparatus according to claim 2, wherein the firmware program causes the apparatus to further operate prohibiting access to the second auxiliary storage device except for a case when the user authentication is successful for the supervisor privilege.

4. The apparatus according to claim 3, wherein the firmware program causes the apparatus to further operate deleting the authentication failure processing program when the supervisor privilege is deleted.

5. The apparatus according to claim 1, wherein the firmware program causes the apparatus to further operate prohibiting access to the first auxiliary storage device when the user authentication fails.

6. The apparatus according to claim 1 further comprising a circuit board on which the second auxiliary storage device is directly mounted to be undetachable.

7. The apparatus according to claim 1, wherein the authentication failure processing program causes the processor to perform an authentication failure process to notify the user that the user authentication is failed.

8. The apparatus according to claim 7 further comprising a display device,
wherein the authentication failure processing program causes the processor to control the display device to display an image notifying the user that the user authentication is failed.

9. The apparatus according to claim 7 further comprising a speaker,
wherein the authentication failure processing program causes the processor to control the speaker to output sound notifying the user that the user authentication is failed.

10. The apparatus according to claim 9, wherein the authentication failure processing program causes the processor to control the speaker to output large warning sound.

11. The apparatus according to claim 7 further comprising a network interface that is connectable to a computer network,
wherein the authentication failure processing program causes the processor to control the network interface to transmit a message through the computer network to a supervisor notifying the user that the user authentication is failed.

12. The apparatus according to claim 1 further comprising an imaging device that captures an image,
wherein the authentication failure processing program causes the processor to control the imaging device to capture an image of the user.
